(19) United States
(12) Patent Application Publication
(10) Pub. No.: US 2017/0328345 A1
(43) Pub. Date: Nov. 16, 2017

(54) STABILIZED MICRO SPATIAL WIND VECTOR DETECTION APPARATUS AND METHOD FOR USE IN MARINE ENVIRONMENTS

(71) Applicant: David Grober, Marina Del Rey, CA (US)

(72) Inventor: David Grober, Marina Del Rey, CA (US)

(21) Appl. No.: 15/592,140

(22) Filed: May 10, 2017

Related U.S. Application Data
(60) Provisional application No. 62/334,355, filed on May 10, 2016.

(51) Int. Cl. F03D 7/04; F03D 17/00; G01P 13/00; G01P 5/24; G05D 1/10; B63B 35/44; B63B 39/00; B64C 39/02; F03D 7/02; H04N 5/445; G01P 5/00

(52) U.S. Cl. CPC F03D 7/048; H04N 5/44504; F03D 17/00; G01P 13/0006; G01P 5/241; G01P 5/001; G05D 1/101; B63B 35/44; B63B 39/00; B64C 39/024; F03D 7/0204; B64C 2201/12; B64C 2201/027; B63B 2035/446; F05B 2240/93; F05B 2270/20; F05B 2270/32; F05B 2270/321

(57) ABSTRACT

A wind detection apparatus detects wind vectors across a predetermined area at high resolution from a floating support. The apparatus includes a Doppler-based wind vector detection unit configured to detect wind direction, velocity, and turbulence, at selected intervals over the predetermined area. A stabilizer supports the wind vector detection unit and is configured to hold it level relative to a predetermined two-dimensional plane. A processor is provided for rendering the wind vector data into a combined representation of wind patterns across the predetermined area, and the processor continuously updates the rendered combined representation of wind patterns in tandem with the detection unit.

This application claims the benefit of the priority filing date of U.S. provisional application No. 62/334,355, filed on 10 May 2016, which incorporated herein in its entirety.

### BACKGROUND

The primary object of this apparatus and/or method is to provide stabilized micro spatial wind mapping for use in maritime environments, and would also include moving environments such as for use on moving vehicles. Current wind and weather mapping is on a meso scale of 1 km-10 km, or greater, and which is limited to time scales of 30 minutes or more. The current apparatus and system is a means and method for creating near-instantaneous micro-scale spatial wind maps of a resolution starting at a few meters on up. This patent provides how to obtain this accuracy, called micro-spatial wind mapping when in a moving environment such as on a body of water, or when the sensor, in this case a wind sensing LIDAR, is on a moving platform such as a boat or vehicle.

Compactness in size and lightness of weight are of significant importance. This invention provides a micro mapping system small enough to go aboard small boats, buoys or platforms.

In situ, real time wind mapping is useful for a variety of applications ranging from outdoor sports such as sailing and kiting, to tracking wind and wind gusts that would affect decision-making for offshore wind farms.

Wind forecasts designed to forecast over several hundred meter scales are usually made using algorithms coming from large-scale model data having a scale of about 10 km, which give, at best, 30 minutes if not an hour or more lead-time to changing local conditions. Although using algorithms the resolution scale can be decreased, the accuracy is greatly diminished and the computational demands prohibit providing local predictions on the scale of minutes, much less seconds. It is the micro-scale variability of wind vector changes, sudden wind gusts, and up and downdrafts that have impacts on outdoor events such as sailing and kite boarding competitions. Furthermore, wind farms, when located on the water, are more efficient if the incoming wind vectors that will act upon wind turbines or other wind generating devices, can be accurately predicted with only seconds to several minutes notice. This would allow each individual turbine to be tuned, blade pitch and azimuth orientation for incoming wind conditions. The use of algorithms, when applied to the stabilized LIDAR wind data can automatically tune individual wind turbines.

Where local variations of wind, occurring on the scale of tens of meters and taking place over a period of seconds to minutes could not previously be scientifically quantified accurately, this apparatus and/or method changes that. Where wind data using local terrain and atmospheric models have been approximate at best, and are unable to provide accurate micro scale mapping, such as for real time wind conditions, wind shifts and stagnation that occur on a local sailboat racing course which may cover 10 kilometers or less per side, this apparatus and/or method changes that. This apparatus and/or method circumvents dependence on local models and puts in place real time, in situ data collection and micro scale mapping, particularly for maritime environments where here-to-for it has been difficult if not impossible to place or use accurate sensing devices.

This apparatus and/or method further adds autonomy to the process of gathering and mapping wind and other weather factors on a micro scale over both water and in littoral areas. By further overlaying combinations of known geophysical attributes from landmasses, the water column and the seabed, as well as historical or real time data including water column depth, temperature and salinity, and further applying atmospheric conditions such as wind and humidity, a micro scale map with an order of resolution on the order of 25 meters or less can be accurately created.

In another embodiment, this apparatus and/or method utilizes the addition of unmanned drone aircraft such as quad copters, physically stationed as part of the apparatus' physical structure, be it secured to the sea floor or being a buoy or vessel, aka “home base” and from which drone(s) collect local atmospheric data, returning to home base, recharging and/or downloading data and preparing to launch for further flight. The home base may also have its own energy scavenging apparatus such as solar cells, wave motion generators or a wind turbine.

A further embodiment includes instrumentation such as a LIDAR, which is stabilized against the motion of the home base, essentially stabilizing the LIDAR or other weather gathering instrumentation against vessel or buoy motion. Specifically for LIDAR, such as Coherent Doppler Wind LIDAR (Wind LIDAR), part of what is claimed is the addition of stabilization where the LIDAR may have a scanning apparatus but when used upon water or other moving platform, such as, but not limited to a buoy, stabilization allows the accurate collection of data precluding the effects of wave motion. For LIDARs that can scan and capture hemispherical data, the use of active stabilization like a Perfect Horizon Stabilizer, U.S. Pat. No. 6,611,662, will significantly improve the accuracy assessment.

In another embodiment, the apparatus and/or method is used for sporting events such as sailing, windsurfing and kite boarding. One or more stabilized LIDARs are placed in or around the course of a sailing or other wind dependent sporting event. The apparatus and/or method creates a micro scale almost-instantaneous wind map of the course that is used by the contestants to augment their tactical decisions.

In another embodiment for sporting events such as sailing, windsurfing and kite boarding, the apparatus and/or method provides a TV, computer-web, or shore-side viewing audience with a real time, micro scale, accurate, instantaneous wind map of the course. This is highly desirable. The audience will have a better perception of how the contestants are reading and reacting to course conditions. In events were the contestants are not allowed, or do not have access to micro scale wind mapping or related real time weather conditions, the ability of an audience to know actual course conditions, and view them on an overlay screen, while watching, for example, yacht skippers try and “read” the course and make tactical decisions, makes for even more interesting and compelling viewing. It also adds to the ability of event commentators to accurately predict outcomes as well as undertake real time strategy assessments.

In another embodiment, the apparatus and/or method is used on wind farms, in particular, off-shore wind farms. There is an advantage to being able to accurately know and assess close-in local wind and weather data. There is also an advantage to using this apparatus and/or method versus launching one-use untethered weather balloons with a radiosonde device. Weather balloons are soon out of range, could get caught in wind turbine blades, and would eventually drop back into the ocean where their balloons, lines, and batteries become an environmental hazard. Tethered balloons pose other complications when being reeled out and reeled in.

In a further embodiment, the data is fed into wind farm administrative or control systems that can control wind turbine factors that may include blade pitch, blade speed, pointing direction and other factors that would make wind turbines more efficient individually or as a farm. Furthermore, having micro scale wind data can allow wind farms to better dovetail their output to the needs of the overall energy grid.

In one embodiment, pertaining to Real Time Micro Scale Wind Information, the apparatus and/or method provides wind information in 25 meter long and 1 meter wide blocks over a 3-5 km range and 1 km height. By use of a single stabilized LIDAR at the center of a racing course, or multiple stabilized LIDAR systems at strategic locations around the course, when combined with GPS tracking and processing software, it is possible to provide real time winds (now cast) over the entire race course with wind speed and direction updates every minute or better. The apparatus and/or method using measurement algorithms and display technology, completely avoids the reliance on (questionable) model-based predictions. The apparatus and/or method can provide data by projecting on a TV or computer screen an instantaneous review of the wind conditions over the entire race course with a high resolution. Wind retrieval algorithms have already been developed to provide the micro scale wind maps for research 1. Fernando, H. J. S., Lee, S. M., Anderson, J., Princevac, M., Pardyjak, E. and Grossman-Clarke, S., “Urban Fluid Mechanics: Air Circulation and Contaminant Dispersion in Cities,” Journal of Environmental Fluid Mechanics, 1(1), 107-164, 2001.), which can be easily applied for the stated purposes here.

### SUMMARY

A wind detection apparatus, for detecting wind direction and velocity across a predetermined area at high resolution from a floating support, includes a Doppler-based wind vector detection unit configured to detect wind direction and velocity, and including areas of wind turbulence, at one cubic meter or greater intervals over the predetermined area. The detection unit translates the detected wind direction and velocity into wind direction and velocity data. A stabilizer coupled to the Doppler-based wind vector detection unit is configured to hold the detection unit level relative to a predetermined two-dimensional plane. A processor is included and configured to render the wind direction and velocity data into a combined representation of wind patterns across the predetermined area, and the processor continuously updates the rendered combined representation of wind patterns in tandem with the detection unit.

In another embodiment, the apparatus incorporates an unmanned drone which has a home base fixed on the apparatus, or other suitable location, and the drone flies in the local area of the wind farm and collects atmospheric data. That data is input into the data stream utilized by the wind turbine tuning algorithm and provides efficient wind energy generation. Preferably the drone returns to the home base and is autonomously recharged and re-launched to continue its data collection. Also, the launch and retrieval pad for the drone is stabilized and provides for calibration of the drone's inertial measurement sensors.

A method is also disclosed for detecting wind direction and velocity across a predetermined area at high resolution from a floating support. The method includes providing a stabilizer, providing a detection unit configured to detect the wind direction and the velocity at one cubic meter or greater intervals over the predetermined area, and configuring the stabilizer to hold the detection unit level relative to a predetermined two-dimensional plane. Further steps include fixing the detection unit to the stabilizer such that the stabilizer supports the detection unit, fixing the stabilizer to the floating support, detecting the wind direction and the velocity in the predetermined area; and translating the wind direction and the velocity into wind direction and velocity data.

In alternative embodiments, the method may include the step of employing Doppler-based wind vector detection in detecting the wind direction and the velocity, providing a processor, and configuring the processor to render the wind direction and velocity data into a map representing the wind direction and the velocity at one cubic meter or greater intervals over the predetermined area. Optionally, the map may be superimposed over a live image of the predetermined area, and the superimposed map and life image may be commercially broadcasting the superimposed map and live image.

In one further embodiment, orientation in a plurality of electricity-generating wind turbines may be optimized relative to the wind direction and the velocity using the wind direction and velocity data.

### BRIEF DESCRIPTION OF FIGURES

FIG. 1 illustrates a plan view of a marine-stabilized micro spatial wind vector detection apparatus in operation on a boat race course;

FIG. 2 illustrates an elevation view of a Doppler-based micro spatial wind vector detection apparatus supported by a stabilizer aboard a marine vessel;

FIG. 3 illustrates the marine vessel with the wind vector detection apparatus held in a predetermined plane by the stabilizer;

FIG. 4 illustrates a screen featuring a video of a boat race with a superimposed map of micro spatial wind vectors;

FIG. 5 illustrates a plan view of a wind farm with the micro spatial wind vector detection apparatus in operation; and

FIG. 6 illustrates the use of a drone to collect visual as well as sensor data in a predetermined area.

### DETAILED DESCRIPTION

The following definitions apply to the terms found in this document:

“Floating Support” is any floating platform whether tethered or untethered to the floor of the body of water.

“Predetermined Area” is an area of interest and defined as the area pertinent to the use of the apparatus 10. For a sporting event such as sailing, a racing course may occupy a rectangular shaped area that can be covered by a 30 degree azimuth scan and a vertical height of 100 meters. The predetermined area for a wind farm may include a full hemispherical scan of wind vectors coming towards the wind turbines as well as the disturbed airflow once it hits and goes past the wind turbine.

“Wind Dependent Competition Event” includes sailboat racing, powerboat racing, windsurfing, kite surfing, sail boarding and any other event where wind vectors would have an effect on the results of the competition.

“Now-Cast Data” is data, including graphics or video, collected in real time and which can be broadcast to an audience.

“Micro-Spatial Wind Data” is wind vector information with the resolution of the data being 200 meters or less, or a data point at least every 200 meters over the selected area.

“Micro-Spatial Wind Vector Now-Cast” refers, for instance in a sailboat race, to a real time display of video or graphics of the competitors on the race course combined with micro-spatial wind LIDAR data. The combined video and wind LIDAR vector data presents a real time visual representation of the event complete with the wind vector data affecting the competitors.

“Stabilized Micro-Spatial Wind Vector Now-Cast” is micro-spatial wind vector data wherein the wind LIDAR sensor has been stabilized to remove motion of the vehicle, vessel or platform it is fixed to.

“Live Action Feed” is the immediate representation of the activity such as in sailboat racing. The live action feed would encompass live video from cameras, graphics, photographs and animations that represent the immediate action taking place on the course.

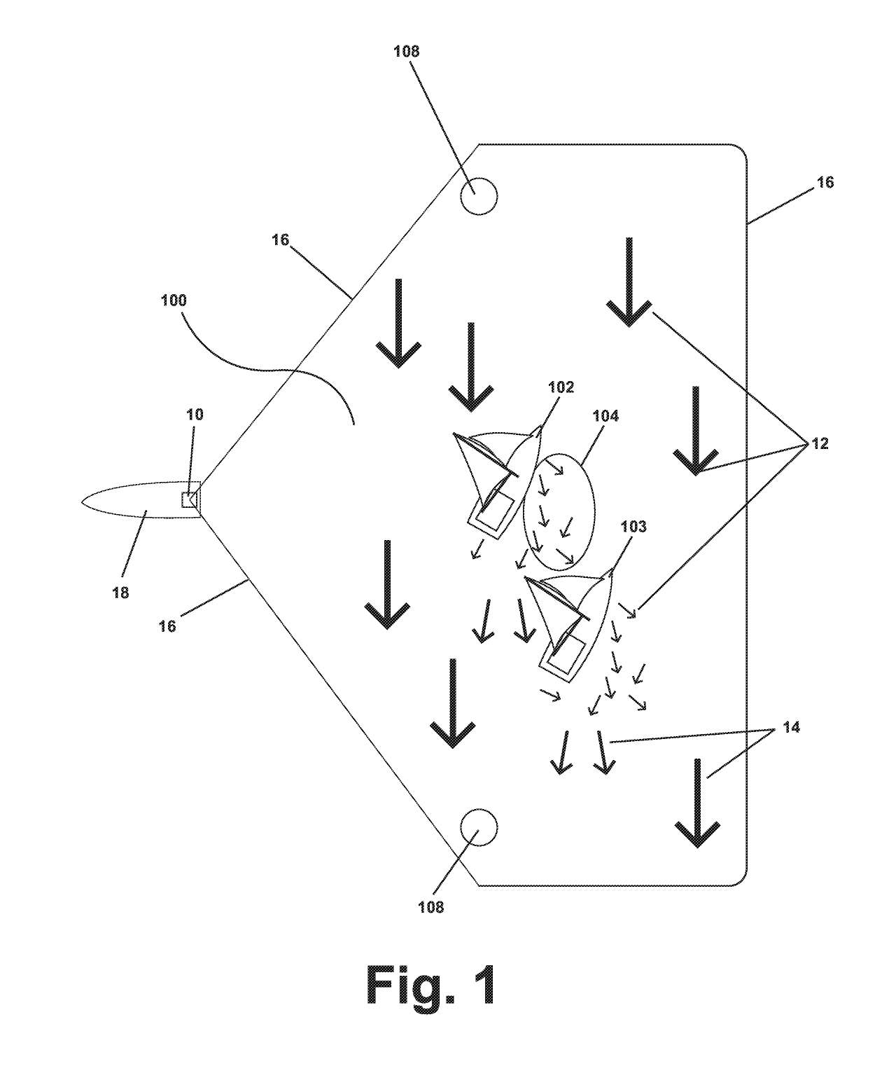

Referring to FIG. 1, an overhead view of a boat race course 100 shows the apparatus 10 in use. The apparatus 10 is used to detect wind direction 12, represented by arrow heads in the figure, and wind velocity 14 represented by arrow tail segment length, and or thickness. The apparatus is used to detect micro spatial wind currents (including direction 12 and velocity 14) over a predetermined area 16. In the illustrated embodiment, the predetermined area is a section of the boat race course 100. Some boat race courses include set boundary lines and penalties or disqualification for exceeding those boundary lines. In such an instance, the predetermined area 16 would correspond with all or part of the boundary. In other instances, where a race course has no set boundary, the predetermined area 16 may be set according to preference.

Since the term ‘wind vector’ as used herein includes two elements, speed and direction, the wind vectors in FIG. 1 are represented as arrows, with the wind speed 12 indicated by the direction of a particular arrow head at its position in the figure, and the wind velocity 14 indicated by the length and thickness of the arrow tail. As shown in the figure, as a strong prevailing wind moves across the course from the top of FIG. 1 to the bottom of FIG. 1, the wind encounters two sailboats 102, 103, that disrupt wind flow. Immediately behind each sailboat are areas of turbulence 104, marked by scattered wind direction and low velocity where the lingering effects of each sailboat 102 are characterized by a reduced wind speed. The course buoys 108 represent the rounding markers for the competitors, and the apparatus 10 is maintained on a floating support 18, such as a non-competition boat, non competition buoy, or other floating object.

Still referring to FIG. 1, the apparatus scans the predetermined area 16 and detects individual instances of wind direction 12 and wind velocity 14 over the predetermined area. In the illustrated embodiment, the predetermined area 16 is an area on the race course corresponding to a section between two buoys 108. The apparatus 10 can be set to scan a specific predetermined area 16 which, depending on the settings of the apparatus 10, may include a horizontal scanned area, or a three dimensional space including height indicators (not shown). In one preferred embodiment, the apparatus 10 is set to scan a full hemispherical space (not shown) in which the apparatus 10 is centered, or it may be set to scan smaller areas according to preference and custom.

Behind the boats 102, 103 are areas of disturbed air and turbulence or the “dirty air”. These disturbed air areas and turbulence 104, often with reduced wind velocity, directly affect the performance of the following competing sailboats 103. Therefore being able to “see” the exact wind direction 12 and wind velocity 14, and areas of disturbed air 104, can help competitors on the course if they have access to that information. Alternatively, in instances where outside information is not allowed to be accessed by competitors, the apparatus 10 becomes particularly useful as a display aid. In such an embodiment, the apparatus 10 allows an announcer and a viewing audience to “see” the wind on the boat race course 100 and anticipate the effect areas of turbulence and reduced wind velocity, 104, will have on the competitors.

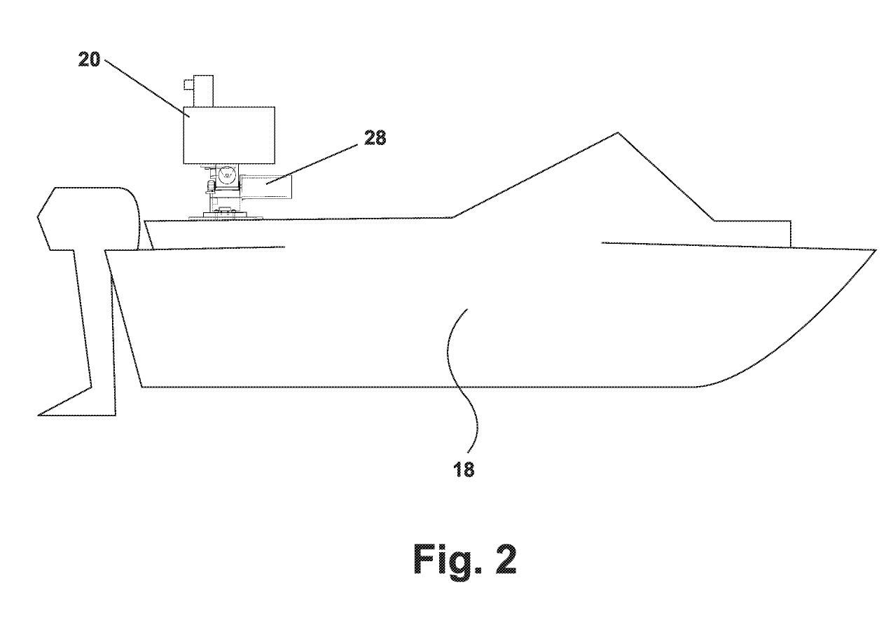

Referring to FIG. 2, FIG. 2 is a boat 18 that acts as a support and moving platform for the invention. The boat can be man operated or autonomous. The boat supports the stabilizer 28, to which is fixed the LIDAR unit or other sensor(s) used to detect wind and atmospheric conditions.

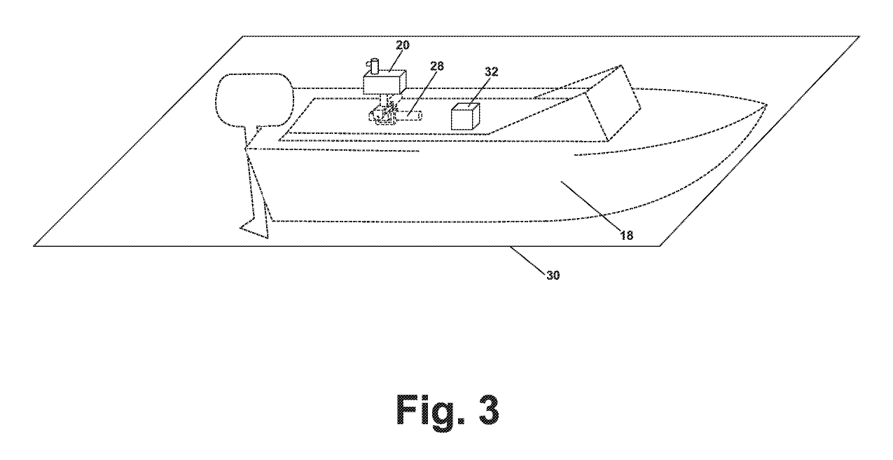

Referring to FIG. 3, FIG. 3 is the boat 18, the stabilizer 28 is mounted to the boat, and upon the stabilizer is the LIDAR 20. The LIDAR 20 can have either a stationary or a moving head to allow it to capture wind vector data for an entire hemisphere, or a more selective area as best suited for the application. The plane 30 is indicative of the horizontal plane of the horizon and to which the LIDAR 20 is stabilized against the pitch and roll of the boat's motion caused by wind, waves or its own propulsion. The processor 32 is configured to provide the wind direction and velocity data to the user. In one embodiment the processor combines wind direction and data and provides a visual representation of wind patterns across the predetermined area. The processor can also add numbers identifying the actual wind speed in addition to wind vectors shown as arrows. The processor continuously updates the rendered combined representation of wind patterns in tandem with the detection unit. The processor 32 can be located at any location where it can receive the data from the detection unit, and provide its data feed to the user.

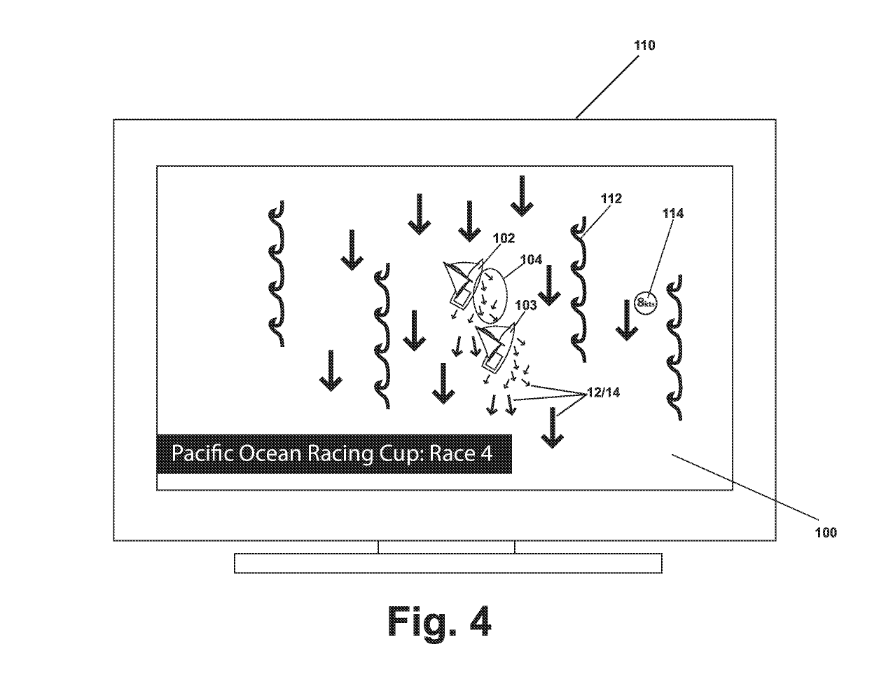

Referring to FIG. 4. FIG. 4 illustrates a sailboat race course as seen on a TV screen, computer screen, or super size screen such as used in concerts or at sporting events. The competitor boats 102, 103 are shown and can be represented by a live video feed, graphics or graphic animation showing the immediate action taking place on the course. This is herein referred to as the “live action feed”. Overlaid on the live action feed is the visual representation of the LIDAR data including the wind vectors 12/14 that show wind direction and relative wind speed. The actual wind speed, generally in knots, can also be superimposed 114 on the live action feed FIG. 4. The wind vectors behind the boats represent these disturbed air areas and turbulence 104. This turbulence, often with reduced wind speed, directly affects the performance of the following competing sailboats 103. Therefore being able to “see” the wind vectors 12/14 can help competitors on the course if they have access to that information. Alternatively, in instances where outside information is not allowed to be accessed by competitors, the apparatus 10 becomes particularly useful as a display aid. In such an embodiment, the apparatus 10 allows an announcer and a viewing audience to “see” the wind on the boat race course 100 and anticipate the effect that areas of turbulence will have on the competitors.

The combination of combining the live action feed, overlaid with visual representations of wind vectors, the combining of these two components results in a “Micro-Spatial Wind Vector Now-Cast” of the event. The method of stabilizing specialized LIDAR, such as Doppler LIDAR, with stabilization, creating a visual representation of wind vectors, and combining or to overlay them on real time images, provides a unique viewpoint of any event that is effected by wind.

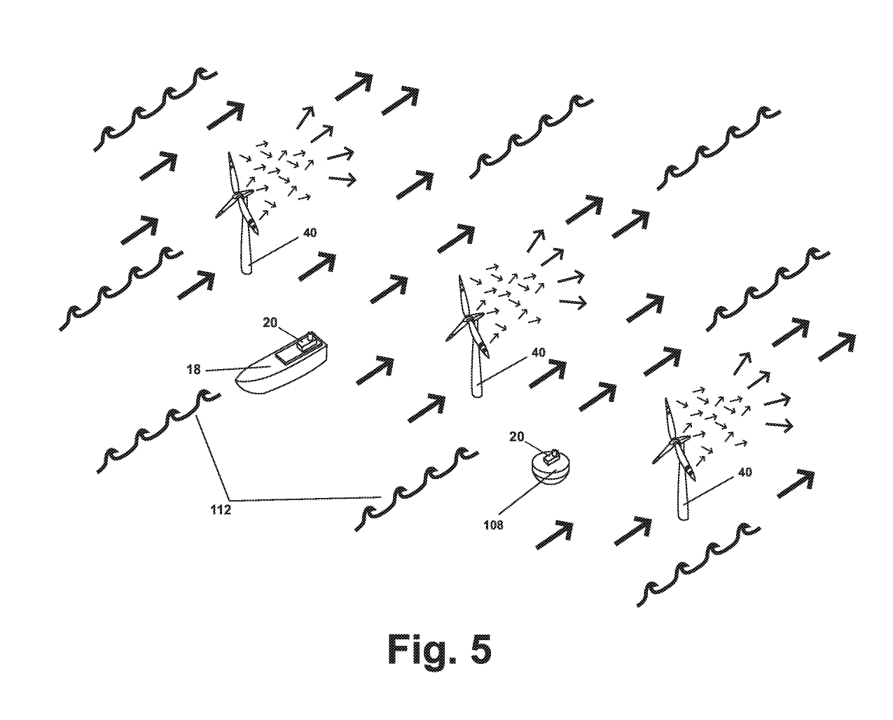

FIG. 5 illustrates a wind farm. Within the wind farm are wind turbines 40, or any other types of wind energy propagating devices. The wind farm is located on the water 112. The illustration shows two types of stabilized platforms. The boat shaped platform is analogous to FIG. 3 and illustrates a boat with a stabilizer and LIDAR 20. The circular floating platform 19, is a buoy that is anchored. It supports a stabilizer 28 that stabilizes the LIDAR 20. Referring to the same illustration, if it did not have wind turbines that are already in place, would represent the use of the apparatus to obtain wind vector data on a moving surface, such as the ocean, to determine the best locations to place wind energy propagating devices.

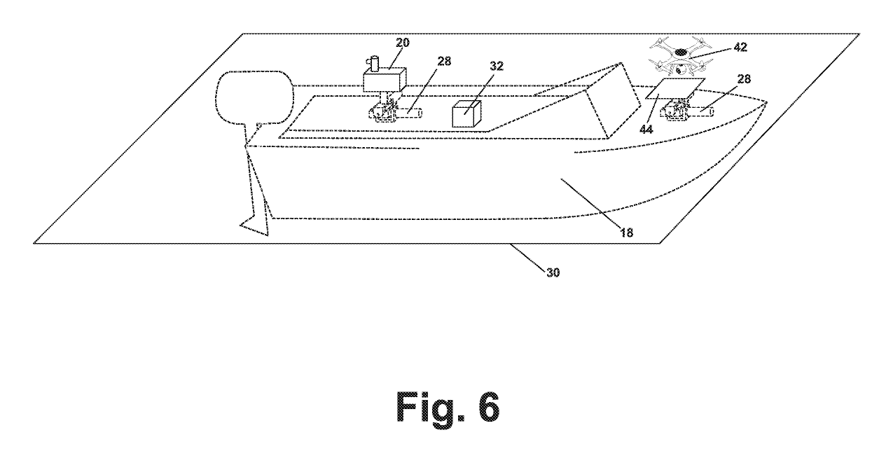

FIG. 6 illustrates the use of a drone 42 to be used in multiple capacities which can include collecting visual as well as sensor data about an event or the wind farm. The data that is collected can include wind vector data, visual imagery such as video, and data from other sensors attached to the drone including temperature, pressure and humidity. The drone has a launch and recovery pad 44 that is stabilized by the stabilizer 28 relative to level 30. Drones often need to have their flight sensors calibrated prior to taking flight. Calibrating flight sensors on a moving platform can lead to misleading and incorrect sensor output. Stabilizing the drone prior to take-off provides for proper flight sensor calibration and is thus important when operating from a moving surface, such as a boat or buoy or float on the water. The processor 32, rear stabilizer 28 for the LIDAR 20 are previously described in FIG. 3.

What is claimed:

1. A wind detection apparatus for detecting wind direction and velocity across a predetermined area at high resolution from a floating support, the apparatus comprising:
a Doppler-based wind vector detection unit configured to detect the wind direction and the velocity, and areas of wind turbulence at one meter or greater intervals over the predetermined area and translate the detected wind direction and the velocity into wind direction and velocity data;
a stabilizer coupled to the Doppler-based wind vector detection unit, the stabilizer configured to hold the detection unit level relative to a predetermined two-dimensional plane;
a processor in electronic communication with the Doppler-based wind vector detection unit configured to render the wind direction and velocity data into a combined representation of wind patterns across the predetermined area; and
the processor continuously updating the rendered combined representation of wind patterns in tandem with the detection unit.

2. A wind detection apparatus for detecting wind direction and velocity across a predetermined area at high resolution from a floating support, the apparatus comprising:
a detection unit configured to detect the wind direction and the velocity at intervals of twenty meters or less over the predetermined area and translate the detected wind direction and the velocity into wind direction and velocity data; and
a stabilizer coupled to the detection unit, the stabilizer configured to hold the detection unit level relative to a predetermined two-dimensional plane.

3. The apparatus of claim 2 wherein the detection unit is a Doppler-based wind vector detection unit.

4. The apparatus of claim 2 wherein the wind direction and velocity data includes areas of wind turbulence.

5. The apparatus of claim 2 further comprising a processor configured to render the wind direction and velocity data into a combined representation of wind patterns across the predetermined area.

6. The apparatus of claim 5 wherein the processor continuously updates the rendered representation of wind patterns in tandem with the detection unit detecting the wind direction and the velocity.

7. The apparatus of claim 2 further comprising an unmanned drone having a home base located at a wind farm for the launch and retrieval of drones, a launch and retrieval pad being stabilized in pitch and roll, the drone configured to fly above and about the wind farm collecting data, and wherein the data is input into a data stream utilized by a wind turbine tuning algorithm to provide efficient wind energy generation.

8. The apparatus of claim 7 wherein the drone is further configured to return to the drone home base for autonomous recharge and re-launch to continue its data collection.

9. The apparatus of claim 7 wherein the stabilizer is configured as a launch and retrieval pad for the drone, and a calibration surface for a measurement sensor in the drone.

10. A method of detecting wind direction and velocity across a predetermined area at high resolution from a floating support, the method comprising:
providing a detection unit configured to detect the wind direction and the velocity at one meter or greater intervals over the predetermined area;
providing a stabilizer configured to maintain a constant level relative to a predetermined two-dimensional plane;
placing the stabilizer on the floating support;
placing the detection unit on the stabilizer; and
transmitting wind vector data based on the wind direction and the velocity occurring at the intervals.

11. The method of claim 10 further comprising the step of employing Doppler-based wind vector detection in detecting the wind direction and the velocity.

12. The method of claim 10 further comprising the step of providing a processor.

13. The method of claim 12 further comprising the step of the configuring the processor to render the wind direction and velocity data into a map representing the wind direction and the velocity at one cubic meter or greater intervals over the predetermined area.

14. The method of claim 13 further comprising the step of superimposing the map representing the wind direction and the velocity over a live image of the predetermined area.

15. The method of claim 14 further comprising the step of commercially broadcasting the superimposed map and live image.

16. The method of claim 10 further comprising the step of optimizing orientation in a plurality of electricity-generating wind turbines relative to the wind direction and the velocity using the wind direction and velocity data.
